(19) United States
(12) Patent Application Publication
(10) Pub. No.: US 2017/0048586 A1
(43) Pub. Date: Feb. 16, 2017

(54) METHODS AND APPARATUSES FOR OPERATING AND PLAYING A CHANNEL OF A SMART TV SET

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventors: Mogang WANG, Tianjin (CN); Min WANG, Tianjin (CN)

(21) Appl. No.: 15/245,266

(22) Filed: Aug. 24, 2016

Related U.S. Application Data
(63) Continuation of application No. PCT/CN2016/086584, filed on Jun. 21, 2016.

(30) Foreign Application Priority Data
Aug. 12, 2015 (CN) 201510497041.0

(51) Int. Cl. H04N 21/482; H04N 21/438; H04N 21/41; H04N 21/488; H04N 21/2187; H04N 21/84

(52) U.S. Cl. CPC H04N 21/482; H04N 21/2187; H04N 21/84; H04N 21/4126; H04N 21/4882; H04N 21/4382

(57) ABSTRACT

Disclosed are methods for operating and playing a channel of a smart TV set, and corresponding apparatuses. The method for operating a channel of a smart TV set includes: detecting an access of an external device to the smart TV set operating with a specified user interface; parsing a live network source file for live network source information upon detecting an access of an external device to the smart TV set, and the live network source file pre-stored in the external device; and adding a live network channel to a list of customized channels on the specified user interface according to the live network source information, so that a user can add a live network channel to the smart TV set on his or her own initiative to thereby better satisfy the user and improve the experience of the user.

### CROSS-REFERENCE TO RELATED APPLICATIONS

This application is a continuation of International Application No. PCT/CN2016/086584, filed on Jun. 21, 2016, which is based upon and claims the benefit of Chinese Patent Application No. 201510497041.0, filed on Aug. 12, 2015, both of which are hereby incorporated by reference in their entireties.

### FIELD

The present disclosure relates to the field of smart TV sets, and particularly to methods for operating and playing a channel of a smart TV set, and corresponding apparatuses.

### BACKGROUND

Smart TV sets are new products emerging as a result of the developing Internet with the aim of bringing a more convenient experience to their users, and have become the popular trend of TV sets. A large number of video sources are generally prepared for the users in the smart TV sets, and in order to satisfy the users with different hobbies, the users are further provided by the smart TV sets with carousel desktop on which there are a number of carousel channels, e.g., a general channel, a movie channel, a teleplay channel, a cartoon channel, a sports channel, a documentary channel, a music channel, etc. The users can select their favorite one of the carousel channels to be played, on the carousel desktop to play a program, or can switch between the carousel channels to be played, through a remote controller.

Although the carousel desktop emerging in the smart TV sets significantly satisfy their watching users, many users still prefer to collect live network sources over the Internet through their Personal Computers (PCs), and watch programs available from these live network sources over the Internet, including various local channels, live overseas sources, professional channels, educational channels, etc.

The experience of watching on the PCs is inferior to the experience of watching on the smart TV sets. The users still watch the programs available from these live network sources over the Internet despite the inferior experience of watching on the PCs because these live network sources are absent in the smart TV sets, and there has been absent so far a solution to a user adding a live network source to a smart TV set on his or her own initiative. In view of this, it is highly desirable at present in the industry to address how to enable a user to add a live network source to a smart TV set on his or her own initiative.

### SUMMARY

Embodiments of the disclosure provide methods for operating and playing a channel of a smart TV set, and corresponding apparatuses so as to address the drawback in the prior art that a user can not add a live network source to a smart TV set on his or her own initiative, to thereby satisfy the user so as to improve the experience of the user.

Some embodiments of the disclosure provide a method for operating a channel of a smart TV set, the method including:

detecting whether there is an access of an external device to the smart TV set when the smart TV set operates in a specified user interface;

upon detection of the access of the external device to the smart TV, and when the external device pre-stores a live network source file, parsing the live network source file to obtain live network source information; and

adding a live network channel to a list of customized channels on the specified user interface according to the live network source information.

Some embodiments of the disclosure provide a method for playing a channel of a smart TV set, the method including:

receiving a playing instruction to play a live network channel in a list of customized channels on a specified user interface when the smart TV set operates in a specified user interface;

playing the live network channel through hard decoding in response to the playing instruction; and

playing the live network channel through soft decoding if the live network channel fails to be played through hard decoding.

Some embodiments of the disclosure provide an electronic device, including:

at least one processor; and

a memory communicably connected with the at least one processor for storing instructions executable by the at least one processor, wherein execution of the instructions by the at least one processor causes the at least one processor to:

detect whether there is an access of an external device to the smart TV set when the smart TV operates in a specified user interface;

upon detection of the access of an external device to the smart TV, and when the external device pre-stores a live network source file, parse the live network source file to obtain live network source information; and

add a live network channel to a list of customized channels on the specified user interface according to the live network source information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for operating a channel of a smart TV set according to some embodiments of the disclosure;

FIG. 2 is a flow chart of adding a created live network channel to a list of customized channels on a specified user interface according to some embodiments of the disclosure;

FIG. 3 is a flow chart of playing a live network channel according to some embodiments of the disclosure;

FIG. 4A is a schematic structural diagram of an apparatus for operating a channel of a smart TV set according to some embodiments of the disclosure;

FIG. 4B is a schematic structural diagram of another apparatus for operating a channel of a smart TV set according to some embodiments of the disclosure;

FIG. 4C is a schematic structural diagram of a further apparatus for operating a channel of a smart TV set according to some embodiments of the disclosure; and

FIG. 5 is a schematic structural diagram of an apparatus for playing a channel of a smart TV set according to some embodiments of the disclosure;

FIG. 6 is a schematic structural diagram of an apparatus for operating a channel of a smart TV set according to some embodiments of the disclosure;

FIG. 7 is a schematic structural diagram of the apparatus for playing a channel of a smart TV set according to some embodiments of the disclosure; and

FIG. 8 is a schematic structural diagram of an electronic device according to some embodiments of the disclosure.

### DETAILED DESCRIPTION OF THE EMBODIMENTS

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

Referring to FIG. 1, a method for operating a channel of a smart TV set according to some embodiments of the disclosure is performed particularly in the following flow:

The step 11 is to detect whether there is an access of an external device to the smart TV set, when the smart TV set operates in a specified user interface.

Here the external device can be a device capable of storing, e.g., a Universal Serial Bus (USB) device.

When the external device is a USB device, for example, then the step 11 can be performed as follows without any limitation thereto:

An access of the USB device to the smart TV set is detected upon reception of a pre-registered USB broadcast notice message which can include any one of:

android.intent.action.MEDIA_EJECT;

android.intent.action.MEDIA_MOUNTED;

android.intent.action.MEDIA_REMOVED; and

android.intent.action.MEDIA_UNMOUNTED.

The step 12 is to parse a live network source file to obtain live network source information upon detection of an access of an external device to the smart TV set, and when the external device pre-stores the live network source file.

Take the external device being a USB device as an example, when a user inserts the USB device into the smart TV set, then the USB device firstly is loaded in the smart TV set, and when the USB device is loaded successfully, then the USB device transmits a USB broadcast notice message to the smart TV set, and the smart TV set determines a path of the USB device according to the received USB broadcast notice message. Then the smart TV set searches the entire USB device for a live network file over the path of the USB device, and parses the live network source file searched out to obtain live network source information.

Particularly the live network source file pre-stored in the external device can be an xx.tv file, which can be created and stored in advance by the user according to the names and the play addresses of live network sources, so the smart TV set can split the xx.tv file searched out under some rule, parse it per row, obtain channel name of each channel (i.e., the name of the live network source), and channel stream address of the channel (i.e., the play address of the live network source) iteratively via a Java split interface, and convert them into Java objects to facilitate a subsequent operation.

Also the obtained live network source information can be further converted into a preset data structure, and can be stored into a local database (e.g., a Sqlite database).

For example, the preset data structure can be:

Channel name+Space/Comma+Live URL+[Space/Comma+Channel icon URL], where the items between the square brackets are optional parameters.

The step 13 is to add a live network channel to a list of customized channels on the specified user interface according to the obtained network source information.

Here when the live network source information includes the name and the play address of the live network source, then the live network channel can be added to the list of customized channels on the specified user interface with the name of the live network channel being the names of the live network sources, and the play address of the live network channel being the play address of the live network source.

In a particular implementation, after the live network source information is stored in the local database of the smart TV set, the live network source information is loaded by the local database, and the list of customized channels on the specified user interface is refreshed in a User Interface (UI) asynchronous handling mechanism so that the live network channel corresponding to the live network source information is added to the list of customized channels on the specified user interface for presentation to the user and use by the user.

Still take the external device being a USB device as an example, after the live network channel is added successfully, a message alert box indicating “Y channels including xxxx, etc., fetched from the USB device” can be popped out to the user, where the message alert box can disappear automatically after being displayed for several seconds. Here “xxxx” refers to the name of a live network channel, and “Y” refers to the number of added live network channels.

In the embodiment of the disclosure, whether there is an access of an external device to the smart TV set is detected, and if an access of an external device to the smart TV set, and a live network source file is pre-stored in the external device are detected, then the live network source file can be parsed to obtain live network source information, and corresponding live network channel can be added to the list of customized channels according to the obtained live network source information, so that the live network channel can be added by the user to the smart TV set on his or her own initiative, so the user can play channels available in the smart TV set, and also can extend more free live network channels freely to thereby better satisfy the user so as to improve the experience of the user.

It shall be noted that the “specified user interface” as referred above to can be any one user interface in the smart TV set, and it can particularly refer to a carousel interface in the smart TV set.

The technical solution according to the embodiment of the disclosure will be described below taking a carousel interface as an example.

When the live network channel is added to the list of customized channels on the carousel interface in the step 13, if the list of customized channels on the carousel interface already has the same channel (i.e., with the same name and play address) as the live network channel, then the addition of the channel can waste processing resources of the smart TV set.

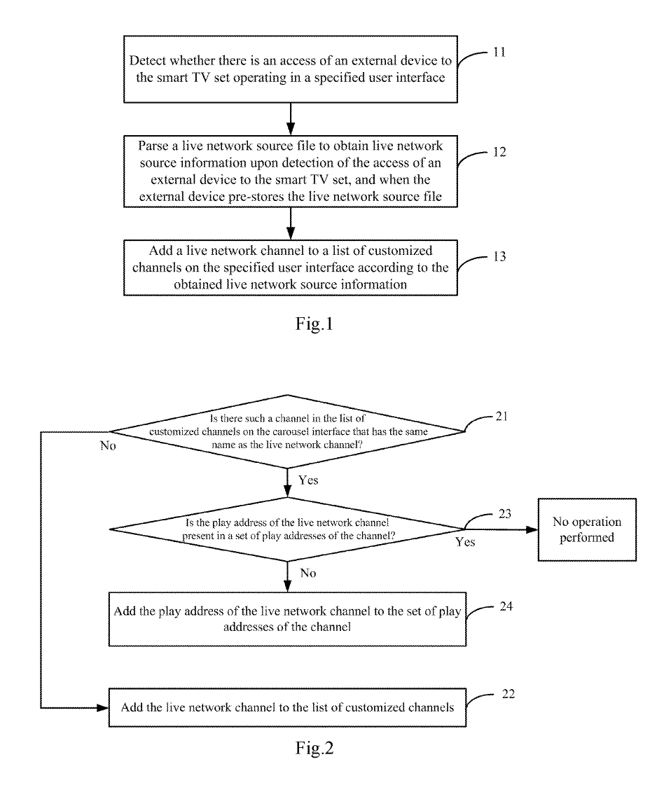

Thus in order to further save the processing resources of the smart TV set, the step 13 above can be performed particularly in the flow as illustrated in FIG. 2:

The step 21 is to determine whether there is such a channel in the list of customized channels on the carousel interface that has the same name as the live network channel.

If not, then the step 22 will be performed; otherwise, the step 23 will be performed.

The step 22 is to add the live network channel to the list of customized channels. The flow ends.

The step 23 is to further determine whether the play address of the live network channel is present in a set of play addresses of the channel with the same name as the live network channel.

If the play address of the live network channel is absent in the set of play addresses of the channel with the same name as the live network channel, then the step 24 will be performed.

If the play address of the live network channel is present in the set of play addresses of the channel with the same name as the live network channel, which indicates that the live network channel is present in the list of customized channels, then no operation will be performed.

The step 24 is to add the play address of the live network channel to the set of play addresses of the channel with the same name as the live network channel.

That is, one channel can correspond to a number of play addresses in the embodiment of the disclosure.

In the embodiment of the disclosure, the name and the play address of the live network channel are compared with the names and the play addresses of the channels in the list of customized channels, and the live network channel is added according to the result of the comparison, to thereby save processing resources of the smart TV set.

Furthermore after the live network channel is added to the list of customized channels on the carousel desktop in the step 13 above, the user can operate the live network channel, for example, delete the live network channel, add the live network channel to my favorite, or play the live network channel.

The live network channel is deleted as follows:

A deletion instruction sent by a user equipment to delete the live network channel is received; and

The live network channel is deleted from the list of customized channels in response to the received deletion instruction.

Particularly upon reception of the deletion instruction sent by the user equipment to delete the live network channel, the live network channel can be removed from the list of customized channels on the carousel desktop through the UI asynchronous refresh mechanism, and also the local database can be notified to delete the live network source information corresponding to the live network channel.

Furthermore upon reception of the deletion instruction sent by the user equipment to instruct the smart TV set to delete the live network channel, a message alert box indicating “Delete ‘the name of the live network channel’ or not?” can be further popped up to the user, and the live network channel can be further removed from the list of customized channels on the carousel desktop upon reception of a confirmation instruction transmitted by the user.

After the live network channel is deleted successfully, a message alert box indicating “‘The name of the live network channel’ has been deleted’” can be further popped up to the user.

The live network channel is added to my favorite as follows:

An add-to-my-favorite instruction transmitted by the user equipment to add the live network channel to my favorite is received; and

The live network channel is added to a list of favorite channels on the carousel desktop in response to the received add-to-my-favorite instruction for selection and playing by the user.

Particularly upon reception of the add-to-my-favorite instruction transmitted by the user equipment to add the live network channel to my favorite, the live network source information corresponding to the live network channel is identified as “Added to my favorite” in the local database, and also the live network channel is added to the list of favorite channels.

Furthermore upon reception of the add-to-my-favorite instruction transmitted by the user equipment to add the live network channel to my favorite, a message alert box indicating “Add ‘the name of the live network channel to may favorite’ or not” can be further popped up to the user, and the live network channel can be further added to the list of favorite channels upon reception of a confirmation instruction transmitted by the user.

The live network channel is played as followed:

A playing instruction transmitted by the user equipment to play the live network channel is received; and

The live network channel is played in response to the received playing instruction.

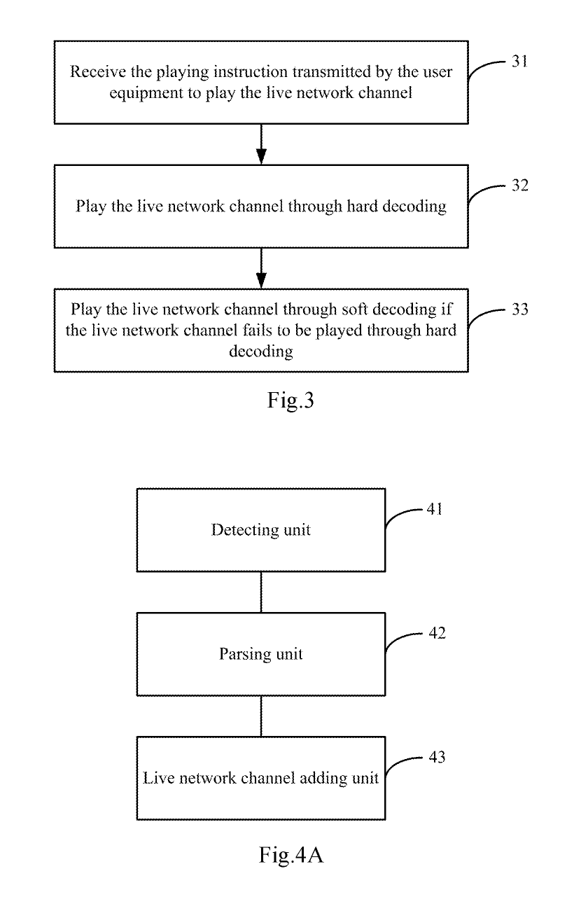

Here while the live network channel is being played, in order to further save processing resources of the smart TV set, and to achieve a better playing effect, and experience of the user, the live network channel can be played in some embodiments of the disclosure in the flow as illustrated in FIG. 3 particularly as follows:

The step 31 is to receive the playing instruction transmitted by the user equipment to play the live network channel;

The step 32 is to play the live network channel through hard decoding;

The so-called hard decoding refers to playing through a hardware parsing module built-in the smart TV. When the live network channel is played through hard decoding, it doesn't need to involve a Central Processing Unit (CPU) of the smart TV set, thus resulting in a better playing effect, and experience of the user.

Particularly the live network channel can be played by the Media Player in the smart TV set, where the Media Player plays the live network channel through hard decoding by default; and

The step 33 is to play the live network channel through soft decoding if the live network channel fails to be played through hard decoding.

In the so-called soft decoding where the live network channel is played in software, a third-party software player needs to be integrated in the smart TV set for playing through soft decoding.

No matter whether the live network channel is played through hard decoding or soft decoding, if there are a number of play addresses in the set of play addresses of the live network channel, then particularly, firstly one of play addresses in a set of play addresses of the live network channel can be selected, and the live network channel can be played at the selected play address; and if the live network channel fails to be played at the selected play address, then the live network channel can be switched automatically to next one of the play addresses of the live network channel in a preset switching order, and played at the next one play address.

It shall be noted that the playing flow above can be applicable to the embodiment of the disclosure without any limitation thereto. That is, if the smart TV set operates in the carousel desktop receives the playing instruction to play one of the live network channels in the list of customized channels on the carousel desktop, then the live network channel in the list of customized channels on the carousel desktop can be played as in the flow above no matter whether the live network channel is added as in the method according to the embodiment of the disclosure.

Based upon the same inventive idea, embodiments of the disclosure further provide apparatus for operating and playing a channel of a smart TV set, and since the apparatuses address the problem under a similar principle to the methods for operating and playing a channel of a smart TV set, reference can be made to the implementations of the methods for implementations of the apparatuses, so a repeated description thereof will be omitted here.

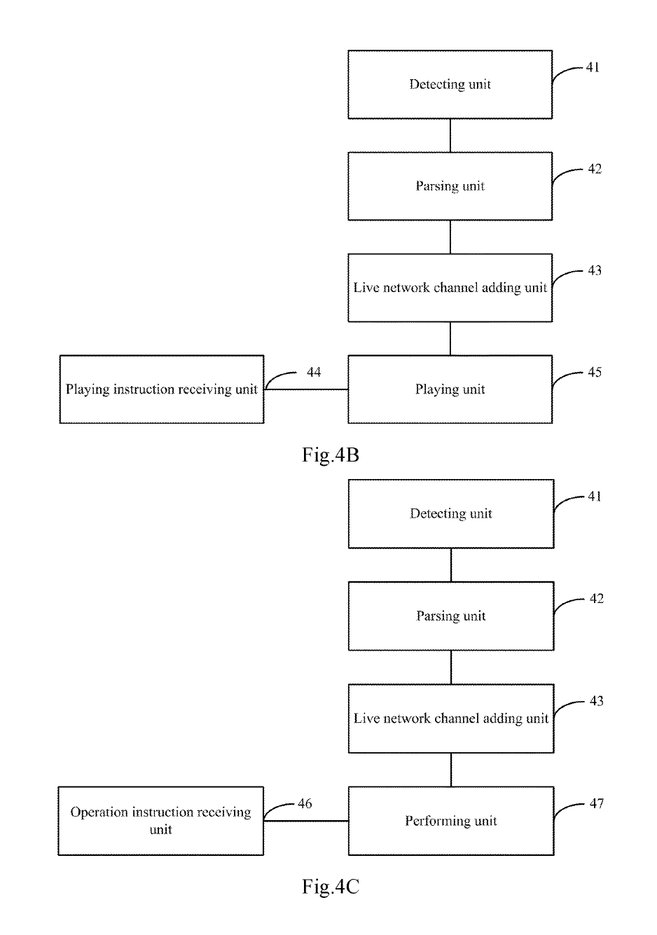

Referring to FIG. 4A, some embodiments of the disclosure provide an apparatus for operating a channel of a smart TV set, where the apparatus includes a detecting module 41, a parsing module 42, and a live network channel adding module 43, all of which can be embodied by a hardware processor, where:

The detecting module 41 is configured to detect whether there is an access of an external device to the smart TV set, when the smart TV operates in a specified user interface;

The parsing module 42 is configured to parse a live network source file to obtain live network source information when the detecting module 41 detects an access of an external device to the smart TV set, and the external device pre-stores the live network source file; and

The live network channel adding module 43 is configured to add a live network channel obtained by the parsing module 42 to a list of customized channels on the specified user interface according to the network source information obtained by the parsing module 42.

Optionally when the live network source information includes the name and play address of a live network source, then:

The live network channel adding module 43 is configured:

To add the live network channel obtained by the parsing module 42 to the list of customized channels on the specified user interface according to the network source information obtained by the parsing module 42 with the name of the live network channel being the name of the live network source, and the play address of the live network channel being the play address of the live network source.

Optionally the live network channel adding module 43 can be configured:

To determine whether there is such a channel in the list of customized channels that has the same name as the live network channel; and

If not, to add the live network channel to the list of customized channels;

Otherwise, if the play address of the live network channel is absent in a set of play addresses of the channel with the same name as the live network channel, to add the play address of the live network channel to the set of play addresses of the channel with the same name as the live network channel.

Optionally the live network channel adding module 43 can be configured:

To store the live network source information in a local database of the smart TV set so that the live network source information is loaded by the local database, and the list of customized channels on the specified user interface is refreshed through an asynchronous handling mechanism so that the live network channel corresponding to the live network source information is added to the list of customized channels on the specified user interface.

Furthermore when the external device is a USB device, then:

The detecting module 41 is configured:

To determine that an access of the USB device to the smart TV set is detected upon reception of a pre-registered USB broadcast notice message; and

The parsing module 42 is configured:

Upon detection of the access of the USB device to the smart TV set by the detecting module 41, to determine a path of the USB device according to the received USB broadcast notice message; to search the USB device for the live network file according to the path of the USB device, and to parse the live network source file searched out to obtain the live network source information.

Optionally the apparatus can further play the added live network channel. Particularly referring to FIG. 4B, another apparatus for operating a channel of a smart TV set according to some embodiments of the disclosure includes:

A detecting module 41, a parsing module 42, a live network channel adding module 43, a playing instruction receiving module 44, and a playing module 45.

Where the detecting module 41, the parsing module 42, and the live network channel adding module 43 are substantially the same as those in FIG. 4A;

The playing instruction receiving module 44 is configured to receive a playing instruction transmitted by a user equipment to play the live network channel; and

The playing module 45 is configured to play the live network channel through hard decoding in response to the playing instruction received by the playing instruction receiving module 44; and if the live network channel fails to be played through hard decoding, to play the live network channel through soft decoding.

Furthermore there are a number of play addresses in the set of play addresses of the live network channel, then the playing module 45 can be configured:

To select one of play addresses in a set of play addresses of the live network channel, and to play the live network channel at the selected play address; and

When the live network channel fails to be played at the selected play address, to switch the live network channel automatically to next one of the play addresses of the live network channel in a preset switching order, and to play the live network channel at the next one play address.

Optionally the apparatus can further delete the added live network channel. Particularly referring to FIG. 4C, a further apparatus for operating a channel of a smart TV set according to some embodiments of the disclosure includes:

A detecting module 41, a parsing module 42, a live network channel adding module 43, an operation instruction receiving module 46, and an performing module 47.

Where the detecting module 41, the parsing module 42, and the live network channel adding module 43 are substantially the same as those in FIG. 4A;

The operation instruction receiving module 46 is configured to receive an operation instruction for the live network channel transmitted by a user equipment, where the operation instruction is a deletion instruction or an add-to-my-favorite instruction; and

The performing module 47 is configured to perform a corresponding operation on the live network channel in response to the operation instruction received by the operation instruction receiving module 46.

In summary, in the embodiment of the disclosure, an access of an external device to the smart TV set is detected, and if an access of an external device to the smart TV set, and a live network source file is pre-stored in the external device are detected, then the live network source file will be parse for live network source information, and corresponding live network channels will be added to the list of customized channels according to the obtained live network source information, so that the live network channels can be added by the user to the smart TV set on his or her own initiative, so the user can play channels available in the smart TV set, and also can extend more free live network channels freely to thereby better satisfy the user so as to improve the experience of the user.

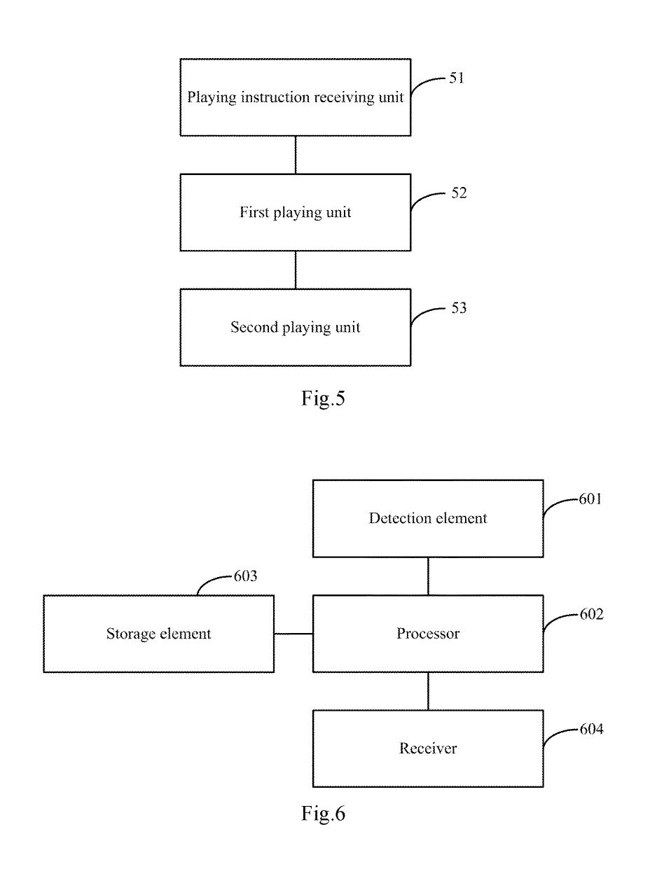

Referring to FIG. 5, an apparatus for playing a channel of a smart TV set according to some embodiments of the disclosure includes a playing instruction receiving module 51, a first playing module 52, and a second playing module 53, all of which can be embodied by a hardware processor, where:

The playing instruction receiving module 51 is configured to receive a playing instruction to play one of live network channels in a list of customized channels on a specified user interface when the smart TV set operates in the specified user interface;

The first playing module 52 is configured to play the live network channel through hard decoding in response to the playing instruction received by the playing instruction receiving module 51; and

The second playing module 53 is configured to play the live network channel through soft decoding if the first playing module 52 fails to play the live network channel through hard decoding.

Based upon the same inventive idea, some embodiments of the disclosure further provide an apparatus for operating a channel of a smart TV set, and since the apparatus addresses the problem under a similar principle to the method for operating a channel of a smart TV set, reference can be made to the implementation of the method for an implementation of the apparatus for operating a channel of a smart TV set, so a repeated description thereof will be omitted here.

As illustrated in FIG. 6, there is a schematic structural diagram of the apparatus for operating a channel of a smart TV set, where the apparatus includes:

A detection element 601 is configured to detect whether there is an access of an external device to the smart TV set, when the smart TV set operates in a specified user interface;

A processor 602 is configured, upon detection of the access of the external device to the smart TV set, and when the external device pre-stores a live network source file, to parse the live network source file to obtain live network source information; and to add a live network channel to a list of customized channels on the specified user interface according to the live network source information; and

A storage element 603 is configured to store the live network source file fetched by the processor 602.

Optionally if the live network source information includes the name and play address of a live network source, then:

The processor is configured:

To add the live network channel to the list of customized channels on the specified user interface according to the network source information, wherein the name of the live network channel is the name of the live network source, and the play address of the live network channel is the play address of the live network source.

Optionally the processor is configured:

To determine whether there is such a channel in the list of customized channels that has the same name as the live network channel; and if there is not such a channel in the list of customized channels that has the same name as the live network channel, to add the live network channel to the list of customized channels; if there is such a channel in the list of customized channels that has the same name as the live network channel, and if the play address of the live network channel is absent in a set of play addresses of the channel with the same name as the live network channel, to add the play address of the live network channel to the set of play addresses of the channel with the same name as the live network channel.

Optionally if the external device is a USB device, then:

The detecting element is configured:

To determine that the access of the USB device to the smart TV set is detected upon reception of a pre-registered USB broadcast notice message; and

The processor is configured:

Upon detection of the access of the USB device to the smart TV set by the detecting element, to determine a path of the USB device according to the received USB broadcast notice message; to search the USB device for the live network file according to the path of the USB device, and to parse the live network source file searched out to obtain the live network source information.

Optionally the processor is configured:

To store the live network source information in a local database of the smart TV set so that the live network source information is loaded by the local database, and the list of customized channels on the specified user interface is refreshed in an asynchronous handling mechanism so that the live network channel corresponding to the live network source information is added to the list of customized channels on the specified user interface.

Optionally the apparatus further includes:

A receiver 604 is configured to receive a playing instruction transmitted by a user equipment to play the live network channel; and

The processor is further configured to play the live network channel through hard decoding in response to the playing instruction received by the receiver; and if the live network channel fails to be played through hard decoding, to play the live network channel through soft decoding.

Optionally there are a number of play addresses in the set of play addresses of the live network channel, then:

The processor is configured:

To select one of play addresses in a set of play addresses of the live network channel, and to play the live network channel at the selected play address; and

If the live network channel fails to be played at the selected play address, to switch the live network channel automatically to next one of the play addresses of the live network channel in a preset switching order, and to play the live network channel at the next one play address.

Based upon the same inventive idea, some embodiments of the disclosure further provide an apparatus for playing a channel of a smart TV set, and since the apparatus addresses the problem under a similar principle to the method for playing a channel of a smart TV set, reference can be made to the implementation of the method for the apparatus for playing a channel of a smart TV set, so a repeated description thereof will be omitted here.

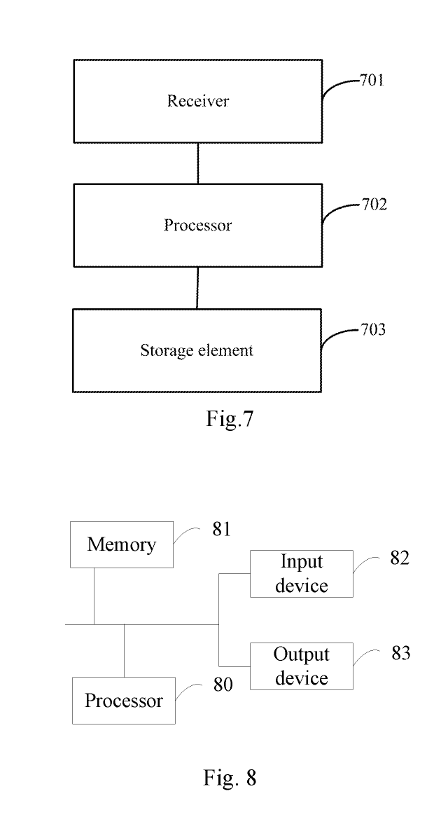

As illustrated in FIG. 7, there is a schematic structural diagram of the apparatus for playing a channel of a smart TV set, where the apparatus includes:

A receiver 701 is configured to receive a playing instruction to play one of live network channels in a list of customized channels on a specified user interface when the smart TV set operates in the specified user interface;

A processor 702 is configured to play the live network channel through hard decoding in response to the playing instruction received by the receiver 701; and to play the live network channel through soft decoding if the live network channel fails to be played through hard decoding; and

A storage element 703 is configured to store data as a result of decoding by the processor.

Optionally the processor is configured to select one of play addresses in a set of play addresses of the live network channel, and to play the live network channel at the selected play address; and

If the live network channel fails to be played at the selected play address, to switch the live network channel automatically to next one of the play addresses of the live network channel in a preset switching order, and to play the live network channel at the next one play address.

Referring to FIG. 8, some embodiments of the disclosure provide an electronic device; the electronic device includes one or more processors 80 and a memory 81. FIG. 8 takes an example of one processor 80.

The electronic device further includes an input device 82 and an output device 83.

The processor 80 and the memory 81 can be connected together by a bus of other connections. The FIG. 8 takes an example of bus connection.

The memory 81 serves as a non-transitory computer-readable storage medium for storing non-transitory programs, non-transitory computer-executable instructions and modules, such as some modules for performing the method for operating a channel of a smart TV set, and the method for playing a channel of a smart TV set according to some embodiments of the disclosure (e.g. modules as shown in FIG. 4A-4C, FIG. 5). The processor 80 performs the method for operating a channel of a smart TV set, and the method for playing a channel of a smart TV set according to some embodiments of the disclosure by executing the non-transitory programs, instructions and modules.

The memory 81 can have a program-storing partition and a data-storing partition. Here the program-storing partition can store operation systems, at least one application for performing a certain function. The data-storing partition can store data generated by operation of the electronic device. Further, the memory 81 can be high-speed RAM, and also non-transitory memory, such as at least one magnetic disk memory device, flash memory or any other non-transitory solid memory device. In some embodiments, the memory 81 can be a remote memory which is arranged in a manner that is away from the processor 80. The remote memories can connected to the electronic device via network, of which instances include but not limit to internet, intranet, LAN, mobile radio communications and combination thereof.

The input device 82 can receive inputted digital or character information, and generate signal inputs concerning user setup and function control of the electronic device. The output device 83 can be display screen and other display devices.

At least one of the modules is stored in the memory 81. When at least one of the modules is executed by the at least one processor 80, it performs the aforementioned method for operating a channel of a smart TV set, and the method for playing a channel of a smart TV set.

The aforementioned electronic device can execute the method according to some embodiments of the disclosure, and has functional modules for executing corresponding method and advantageous thereof. For more technical details, the method according to some embodiments of the disclosure can be referred.

The electronic device according to some embodiments of the disclosure are in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for operating a channel of a smart TV set, the method comprises:
detecting whether there is an access of an external device to the smart TV set when the smart TV set operates in a specified user interface;
upon detection of the access of the external device to the smart TV, and when the external device pre-stores a live network source file, parsing the live network source file to obtain live network source information; and
adding a live network channel to a list of customized channels on the specified user interface according to the live network source information.

2. The method according to claim 1, wherein the live network source information comprises a name and a play address of a live network source, then:
adding the live network channel to the list of customized channels on the specified user interface according to the live network source information comprises:
adding the live network channel to the list of customized channels on the specified user interface according to the network source information, wherein a name of the live network channel is the name of the live network source, and a play address of the live network channel is the play address of the live network source.

3. The method according to claim 2, wherein adding the live network channel to the list of customized channels on the specified user interface according to the live network source information comprises:
determining whether there is such a channel in the list of customized channels that has the same name as the live network channel; and
when there is not such a channel in the list of customized channels that has the same name as the live network channel, then adding the live network channel to the list of customized channels;
when there is such a channel in the list of customized channels that has the same name as the live network channel, and the play address of the live network channel is absent in a set of play addresses of the channel with the same name as the live network channel, then adding the play address of the live network channel to the set of play addresses of the channel with the same name as the live network channel.

4. The method according to claim 1, wherein the external device is a USB device, then:
detecting whether there is the access of the external device to the smart TV set comprises:
determining that an access of the USB device to the smart TV set is detected upon reception of a pre-registered USB broadcast notice message; and
upon detection of the access of the external device to the smart TV, and when the external device pre-stores live network source file, parsing the live network source file to obtain live network source information comprises:
upon detection of the access of the USB device to the smart TV set, then determining a path of the USB device according to the received USB broadcast notice message;
searching the USB device for the live network file according to the path of the USB device; and
parsing the live network source file searched out to obtain the live network source information.

5. The method according to claim 1, wherein adding the live network channel to the list of customized channels on the specified user interface according to the live network source information comprises:
storing the live network source information in a local database of the smart TV set so that the live network source information is loaded by the local database, and the list of customized channels on the specified user interface is refreshed through a user interface asynchronous handling mechanism so that the live network channel corresponding to the live network source information is added to the list of customized channels on the specified user interface.

6. The method according to claim 1, wherein the method further comprises:
receiving a playing instruction transmitted by a user equipment to play the live network channel;
playing the live network channel through hard decoding in response to the playing instruction; and
when the live network channel fails to be played through hard decoding, playing the live network channel through soft decoding.

7. The method according to claim 2, wherein the method further comprises:
receiving a playing instruction transmitted by a user equipment to play the live network channel;
playing the live network channel through hard decoding in response to the playing instruction; and
when the live network channel fails to be played through hard decoding, playing the live network channel through soft decoding.

8. The method according to claim 3, wherein the method further comprises:
receiving a playing instruction transmitted by a user equipment to play the live network channel;
playing the live network channel through hard decoding in response to the playing instruction; and
when the live network channel fails to be played through hard decoding, playing the live network channel through soft decoding.

9. The method according to claim 4, wherein the method further comprises:
receiving a playing instruction transmitted by a user equipment to play the live network channel;
playing the live network channel through hard decoding in response to the playing instruction; and
when the live network channel fails to be played through hard decoding, playing the live network channel through soft decoding.

10. The method according to claim 5, wherein the method further comprises:
receiving a playing instruction transmitted by a user equipment to play the live network channel;
playing the live network channel through hard decoding in response to the playing instruction; and
when the live network channel fails to be played through hard decoding, playing the live network channel through soft decoding.

11. The method according to claim 6, wherein there are a number of play addresses in a set of play addresses of the live network channel, then:
playing the live network channel comprises:
selecting a play address in the set of play addresses of the live network channel, and playing the live network channel at the selected play address; and
when the live network channel fails to be played at the selected play address, then switching the live network channel automatically to next one of the play addresses of the live network channel in a preset switching order, and playing the live network channel at the next one play address.

12. A method for playing a channel of a smart TV set, the method comprises:
receiving a playing instruction to play a live network channel in a list of customized channels on a specified user interface when the smart TV set operates in a specified user interface;
playing the live network channel through hard decoding in response to the playing instruction; and
playing the live network channel through soft decoding if the live network channel fails to be played through hard decoding.

13. An electronic device for operating a channel of a smart TV set, comprising:
at least one processor; and
a memory communicably connected with the at least one processor for storing instructions executable by the at least one processor, wherein execution of the instructions by the at least one processor causes the at least one processor to:
detect whether there is an access of an external device to the smart TV set when the smart TV set operates in a specified user interface;
parse the live network source file to obtain live network source information; and
add a live network channel to a list of customized channels on the specified user interface according to the live network source information.

14. The electronic device according to claim 13, wherein the live network source information comprises a name and a play address of a live network source:
execution of the instructions by the at least one processor causes the at least one processor to:
add the live network channel to the list of customized channels on the specified user interface according to the live network source information, wherein a name of the live network channel is the name of the live network source, and a play address of the live network channel is the play address of the live network source.

15. The electronic device according to claim 14, wherein the execution of the instructions by the at least one processor causes the at least one processor to:
determine whether there is such a channel in the list of customized channels that has the same name as the live network channel; and when there is not such a channel in the list of customized channels that has the same name as the live network channel, add the live network channel to the list of customized channels; when there is such a channel in the list of customized channels that has the same name as the live network channel, and the play address of the live network channel is absent in a set of play addresses of the channel with the same name as the live network channel, add the play address of the live network channel to the set of play addresses of the channel with the same name as the live network channel.

16. The electronic device according to claim 13, wherein the external device is a USB device,
the execution of the instructions by the at least one processor causes the at least one processor to:
determine that the access of the USB device to the smart TV set is detected upon reception of a pre-registered USB broadcast notice message; and
upon reception of the access of the USB device to the smart TV set, determine a path of the USB device according to the received USB broadcast notice message; to search the USB device for the live network file according to the path of the USB device, and parse the live network source file searched out to obtain the live network source information.

17. The electronic device according to claim 13, wherein the execution of the instructions by the at least one processor causes the at least one processor to:
store the live network source information in a local database of the smart TV set so that the live network source information is loaded by the local database, and the list of customized channels on the specified user interface is refreshed through an asynchronous handling mechanism so that the live network channel corresponding to the live network source information is added to the list of customized channels on the specified user interface.

18. The electronic device according to claim 13, wherein execution of the instructions by the at least one processor causes the at least one processor further to:
receive a playing instruction transmitted by a user equipment to play the live network channel; and
play the live network channel through hard decoding in response to the playing instruction; and when the live network channel fails to be played through hard decoding, play the live network channel through soft decoding.

19. The electronic device according to claim 18, wherein there are a number of play addresses in a set of play addresses of the live network channel,
execution of the instructions by the at least one processor causes the at least one processor to:
select one of play addresses in the set of play addresses of the live network channel, and play the live network channel at the selected play address; and
when the live network channel fails to be played at the selected play address, switch the live network channel automatically to next one of the play addresses of the live network channel in a preset switching order, and play the live network channel at the next one play address.
